(19) United States
(12) Patent Application Publication
(10) Pub. No.: US 2024/0145222 A1
(43) Pub. Date: May 2, 2024

(54) ELECTROHYDRODYNAMIC VENTILATION DEVICE

(71) Applicant: CEDRION CONSULTORIA TECNICA E INGENIERIA, S.L., Leganes (Madrid) (ES)

(72) Inventors: Hector PUAGO MARTINEZ, Leganes (Madrid) (ES); Pedro MARTI BALSALOBRE, Leganes (Madrid) (ES); Maria del Mar COGOLLO DE CADIZ, Leganes (Madrid) (ES)

(21) Appl. No.: 18/546,679

(22) PCT Filed: Nov. 17, 2021
(86) PCT No.: PCT/ES2021/070829

§ 371 Date: Aug. 16, 2023

(30) Foreign Application Priority Data
Feb. 18, 2021 (ES) P202130126

(51) Int. Cl. H01J 41/12

(52) U.S. Cl. CPC H01J 41/12

(57) ABSTRACT

An electrohydrodynamic ventilation device with at least one emitter electrode (4) and at least two collector electrodes (3) defining an acceleration channel (6) for the flow of ionic wind between the at least two collector electrodes (3), where the at least one emitter electrode (4) is disposed on the channel (6), throughout the length of the channel (6), where the at least one emitter electrode (4) is configured to be anchored to supports (5) made of insulating material, where each support (5) has a projection section (5′) that is interposed between the at least one emitter electrode (4) and each end (3′) of the at least two collector electrodes (3).

### TECHNICAL FIELD

The object of the present invention is an electrohydrodynamic (EHD) ventilation device which exhibits an improved performance with respect to other conventional electrohydrodynamic devices or thrusters.

The electrohydrodynamic ventilation device of the invention exhibits a lower risk of electric arcs appearing between the emitter electrode and the collector electrode, with respect to other known electrohydrodynamic thrusters, increasing the energy density per unit length of the emitter electrode, thereby causing greater efficiency in the generation of ionic wind.

The electrohydrodynamic ventilation device object of the present invention can be used in the industry of ventilation and surface disinfection systems through the generation of ionic wind.

### STATE OF THE ART

At present, electrohydrodynamic (EHD) ventilation devices or electrohydrodynamic thrusters are known which are based on the generation of a cold plasma by ionisation of the air (or other fluid) located between an emitter electrode disposed at a high electrical potential and a collector electrode that can be connected to ground.

The high concentration of electric field around the emitter electrode produces, due to the corona effect, an ionisation of the surrounding fluid, which is separated into positive and negative ions, by way of a “cold plasma”, where the negative ions are attracted to the collector electrode, thus generating an “ionic wind” with the capacity to ventilate spaces or surfaces such as electronic plates, also producing a disinfection effect on the surface on which the ionic wind current impinges.

Electrohydrodynamic thrusters provide a series of advantages over other forced ventilation devices such as blade fans, since they do not have moving parts, reduce the noise and vibrations generated by said moving elements, and energy efficiency with respect to fans is increased, as there is no friction between moving mechanical elements.

However, one of the drawbacks of conventional electrohydrodynamic devices or electrohydrodynamic thrusters is the risk of the appearance of discontinuous or stable electric arcs between the emitter electrode and the collector electrode. These electric arcs have a high energy density and cause loss of performance, as well as the degradation of the electrodes.

Document US 2011192284 A1 discloses an example of an electrohydrodynamic thruster in which the collector electrode exhibits a shorter length than the length of the emitter electrode or corona electrode. Through this strategy, the aim is to reduce the probability of electric arcs appearing between the end of the collector electrode and the end of the emitter electrode. However, the end of the collector electrode continues to be a point of high electric field density and, despite the strategy adopted in said document, said end of the collector electrode continues to be at the same distance (perpendicular) from the emitter electrode as if the strategy of reducing the length of the collector electrode had not been adopted. Therefore, even with such a strategy, the risk of electric arcs appearing between electrodes remains high.

### OBJECT OF THE INVENTION

In order to solve the aforementioned drawbacks, the present invention relates to an electrohydrodynamic ventilation device.

By means of the electrohydrodynamic ventilation device object of the present invention, currents of fluid (e.g., air) can be generated that dissipate heat from electronic components or that sterilise closed surfaces or environments.

The electrohydrodynamic ventilation device object of the present invention comprises at least one emitter electrode and at least two collector electrodes defining an acceleration channel for the flow of an ionic wind between the at least two collector electrodes.

The at least one emitter electrode is disposed on the channel, parallel to and throughout the length of said channel. The at least one emitter electrode is configured to be anchored (at the ends of said emitter electrode) to supports made of insulating material.

In a novel way, in the electrohydrodynamic ventilation device object of the present invention, each support comprises a projection section that is interposed between the at least one emitter electrode and each end of the at least two collector electrodes.

By means of the electrohydrodynamic ventilation device described above, it is possible to drastically reduce the possible appearance of continuous electric arcs between the emitter electrode (corona electrode) and the end of each collector electrode (which is an area of high electric field concentration and, therefore, an area with the greatest danger of generating electric arcs).

According to a preferred embodiment of the invention, the electrohydrodynamic ventilation device comprises a first body and a second body.

The first body comprises the at least two collector electrodes. The second body comprises the support for the at least one emitter electrode (and also comprises the emitter electrode(s) when it/they is/are anchored to the supports). The second body is configured to be mounted on the first body. This two-body geometry facilitates the manufacture of the electrohydrodynamic ventilation device.

According to a possible embodiment, the at least one emitter electrode is configured to be anchored to the supports by means of screws, so that by screwing or unscrewing the screws, respectively, a tightening or loosening of the at least one emitter electrode is allowed. This embodiment makes it possible to control the voltage to be applied to the cable/wire/emitter electrode.

According to another possible embodiment, the at least one emitter electrode is configured to be anchored to the supports by means of metal plates configured to act by way of springs, making it possible to absorb vibrations or shocks on the electrohydrodynamic ventilation device. This embodiment provides protection against accidental breakage of the emitter electrodes, which could be caused by vibrations or shocks on the electrohydrodynamic ventilation device.

There is also a hybrid embodiment, where the at least one emitter electrode is configured to be anchored to the supports by means of a combination of plates and screws. This embodiment combines the advantages of the two previous embodiments.

Preferably, the electrohydrodynamic ventilation device comprises a plurality of emitter electrodes positioned over a plurality of parallel fluid discharge channels.

Preferably, the electrohydrodynamic ventilation device comprises a spacer made of insulating material on each collector electrode. Said spacer is configured to isolate the emitter electrodes from one another, minimising the interference of the electric field of one emitter electrode with the electric field of another emitter electrode. This characteristic makes it possible to increase the power density per unit length of the emitter electrode.

According to a possible embodiment, each emitter electrode is located at a distance (G) from each collector electrode of between 1 mm and 4 mm. This distance allows adequate ionisation of the fluid (a dielectric fluid, e.g., air).

Preferably, the collector electrodes have a separation (D) from one another of between 1.5 and 2.5 times the distance (G) from the emitter electrode to each collector electrode. This D/G ratio of between 1.5 and 2.5 is much higher than the corresponding ratio found in other state of the art EHD thrusters. This geometric characteristic implies that each emitter electrode wire is discharging to a larger collector electrode surface and avoiding interference in the electric field of the adjacent emitter electrode (corona electrode), improving discharge efficiency, and increasing the power density per length of wire, which makes it possible to manufacture more compact and lightweight EHD air pumps with better performance.

Preferably, the distance (D) between collector electrodes is approximately twice the distance (G) from the emitter electrode to each collector electrode.

Preferably, according to the invention, the length of the projection section is greater than or equal to 1.5 times the distance (G) between each emitter electrode and collector electrode.

According to a possible embodiment, the supports comprise V-shaped channels configured to help position the emitter electrodes correctly and parallelly.

The collector electrodes can have different geometries and, depending on the geometry they adopt, this results in the geometry of the channels defined between the collector electrodes.

According to a possible embodiment, the collector electrodes comprise a drop-shaped geometry generating a NACA-shaped channel (NACA duct) between each two collector electrodes.

According to another possible embodiment, the collector electrodes comprise a partially cylindrical and partially trapezoidal geometry, generating a channel with divergent walls between each two collector electrodes, i.e., the channel having, respectively, an outlet area greater than an inlet area.

In both cases defined above, a channel with a divergent profile is generated that adapts the corona discharge flow to the flow resulting from the outlet of the electrohydrodynamic ventilation device, with minimal aerodynamic losses.

Preferably, each emitter electrode (each wire or corona electrode) is made of tungsten or an alloy with a tungsten content of more than 95%. This provides the emitter electrode with great mechanical resistance, while providing good properties against wear.

Alternatively, the collector electrodes can be made in two portions, with a core made of insulating material and a coating made of conductive material (e.g., metal).

The coating of conductive material can be in the form of a layer of conductive material applied to the core of insulating material or of a part made of conductive material such as, for example, a sheet metal or a machined part, attached to the core of insulating material. Preferably, the collector electrode is in the shape of an aerodynamic profile, with the core of insulating material making up the outlet edge and the coating making up the leading edge of the profile.

This alternative configuration of the two-part collector electrode exhibits a beneficial structure since it allows lower costs by reducing the amount of metal used, in the same way that it reduces the weight of the device.

### DESCRIPTION OF THE FIGURES

The following figures have been included as part of the explanation of at least one embodiment of the invention.

FIG. 1 shows an exploded perspective schematic view of an embodiment of the electrohydrodynamic ventilation device.

FIG. 2 shows a perspective view of the electrohydrodynamic ventilation device of FIG. 1, with its two main parts assembled.

FIG. 3 shows a cross-sectional view of the emitter electrode (corona electrode) and the collector electrodes, where the relative position between electrodes is observed.

FIG. 4 shows a diagram of the electrical supply of the electrohydrodynamic ventilation device.

FIG. 5 shows a schematic cross-sectional view of a possible embodiment of the electrohydrodynamic ventilation device, where the relative disposition between a plurality of emitter electrodes and a plurality of collector electrodes is observed.

FIG. 6a shows a cross-sectional view of the relative arrangement between an emitter electrode and two collector electrodes (forming a channel for ionic flow between both collector electrodes), where the collector electrodes have cylindrical geometry.

FIG. 6b shows a cross-sectional view of the relative arrangement between an emitter electrode and two collector electrodes (which form a channel for ionic flow between both collector electrodes), where the collector electrodes have geometry formed by a cylindrical portion and a prismatic portion that produces a channel for ionic flow having parallel planes.

FIG. 6c shows a cross-sectional view of the relative arrangement between an emitter electrode and two collector electrodes (forming a channel for ionic flow between both collector electrodes), where the collector electrodes have drop-shaped geometry or NACA profile.

FIG. 6d shows a cross-sectional view of the relative arrangement between an emitter electrode and two collector electrodes (forming a channel for ionic flow between both collector electrodes), where the collector electrodes have geometry formed by a cylindrical portion and a trapezoidal prismatic portion that produces a channel for ionic flow having parallel planes.

FIG. 7 shows a schematic view, according to a possible embodiment of the electrohydrodynamic ventilation device, where the anchoring by means of screws of the emitter wires or electrodes (corona electrodes) to their insulating support is observed.

FIG. 8 shows a schematic view, according to an embodiment of the electrohydrodynamic ventilation device, alternative to that of FIG. 7, where the anchoring by means of springs in the form of plates or sheets of the emitter wires or electrodes (corona electrodes) to their insulating support is observed.

FIG. 9a shows a schematic view, according to an embodiment of the electrohydrodynamic ventilation device, alternative to FIG. 7 and FIG. 8, where the anchoring by means of a combination of screws and springs in the form of plates or sheet metal of the emitter wires or electrodes (corona electrodes) to their insulating support is observed.

FIG. 9b shows a schematic side view of the anchoring in FIG. 9a, in a state prior to tightening the screw, where the wire of the emitter electrode is loose.

FIG. 9c shows a schematic side view of the anchoring of FIG. 9a and FIG. 9b, in a tightening state of the screw, where the wire of the emitter electrode is tightened.

FIG. 10 shows a detailed view of the support for the emitter electrodes, according to a possible embodiment of the electrohydrodynamic ventilation device.

FIG. 11 shows a detailed cross-sectional view of the support for the emitter electrodes, according to a possible embodiment of the electrohydrodynamic ventilation device.

FIG. 12a shows a cross-sectional view of a pair of collector electrodes disposed in parallel, wherein said collector electrodes are made of insulating material and comprise a coating of conductive material in the form of a machined part.

FIG. 12b shows a cross-sectional view of a pair of collector electrodes disposed in parallel, wherein said collector electrodes are made of insulating material and comprise a sheet metal coating of sheet-shaped conductive material.

FIG. 13 shows a cross-sectional view of the second body in which different geometries of the support can be seen in the portion facing the first body.

### DETAILED DESCRIPTION OF THE INVENTION

The present invention relates, as previously mentioned, to an electrohydrodynamic ventilation device.

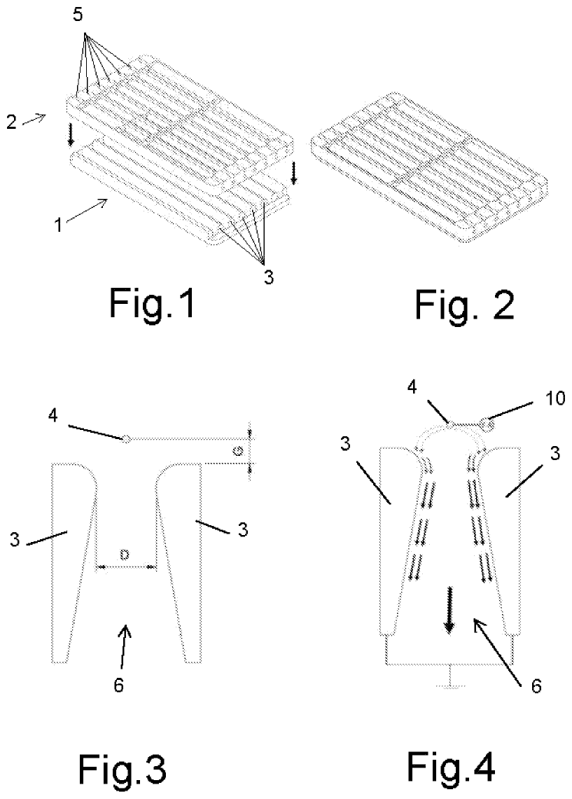

The electrohydrodynamic ventilation device comprises, as can be seen in FIG. 1, a first body (1) comprising the collector electrode assembly (3). The electrohydrodynamic ventilation device comprises a second body (2) comprising supports (5) for the emitter electrode (4) or corona electrode assembly.

The electrohydrodynamic ventilation device is configured so that the second body (2) is mounted on the first body (1), as can be seen in FIG. 2, where both bodies appear already mounted.

FIG. 10 shows a detailed view of the supports (5) (made of electrical insulating material) of the emitter electrodes (4). It can be seen that said supports (5) comprise V-shaped channels to help position the wires of the emitter electrodes (4) correctly and parallelly.

The insulating material in which the supports (5) are made can be selected from among, for example: acrylonitrile butadiene styrene (ABS), polylactic acid (PLA) or polytetrafluoroethylene (Teflon). Preferably, the manufacture of this part is carried out by means of plastic injection.

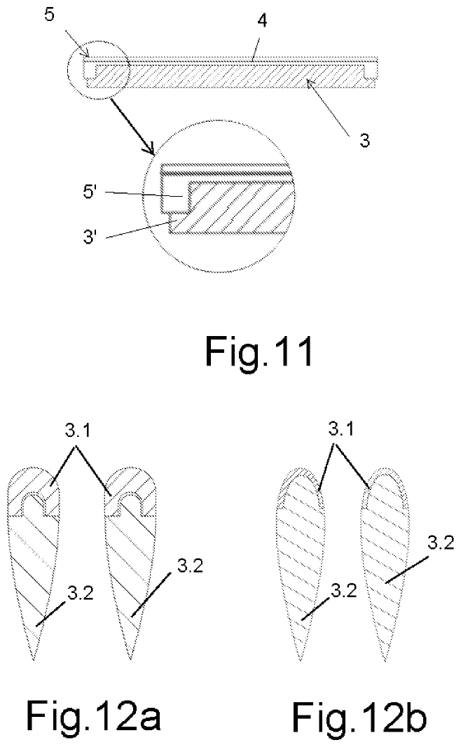

As can be seen in FIG. 11, each support (5) comprises a projection section (5′) that covers the end (3′) of the collector electrodes (3) adjacent to the corresponding emitter electrode (4). In this way, the end (3′) of said collector electrodes (3) (which is a point of high density or high concentration of electric field) is far from the emitter electrode (4), thereby drastically reducing the risk of electric arcs appearing between the emitter electrode (4) and collector electrodes (3).

The collector electrodes (3) form a plurality of channels (6) therebetween through which the ionic wind flow is produced generated by the ionisation of the fluid (e.g., air) around the wires or cables of the emitter electrodes (4) or corona electrodes.

Between the channels (6) there are spacers (7) made of insulating material, which allow the emitter wires or electrodes (4) to be isolated from one another, minimising the interference of the electric field of one emitter electrode (4) with the electric field of another emitter electrode (4). This makes it possible to increase the power density per length of each emitter wire or electrode (4).

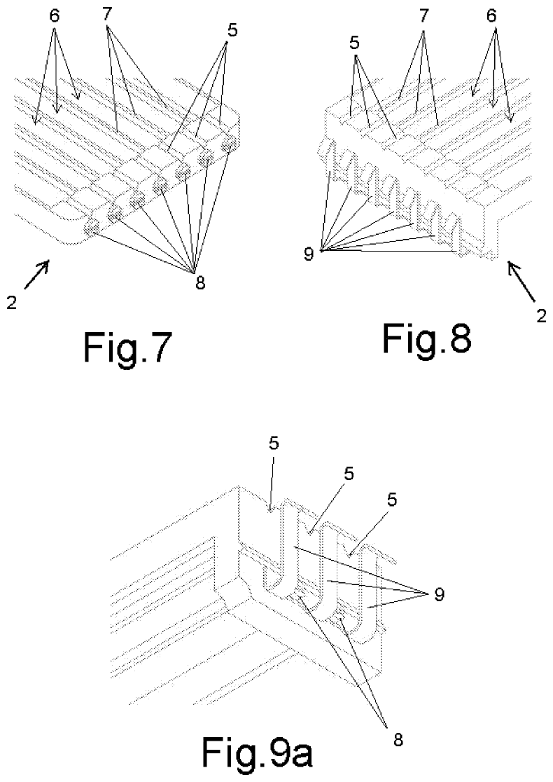

As shown in FIG. 7, the second body (2) can comprise a plurality of screws (8) for anchoring the emitter electrodes (4) to their supports (5), below the supports (5). In this case, each emitter wire or electrode (4) can be wound around each screw (8) and the screw is screwed to the insulating structure of the second body (2). The emitter wire or electrode (4) can be welded at one end to the screw (8). Through the threading of the screw, the tension of the emitter wire or electrode (4) can be adjusted.

Moreover, as shown in FIG. 8, the second body (2) can comprise a plurality of plates (9) or sheet metal for anchoring the emitter electrodes (4) to their supports (5), below the supports (5). The plates (9) can be made of stainless steel. The plates (9) can be glued or inserted in the second body (2), below the supports (5). The emitter wire or electrode (4) can be welded by micro-welding to the plate (9). The plate (9) acts by way of a spring to tighten the emitter wire or electrode (4) and to resist shocks and vibration.

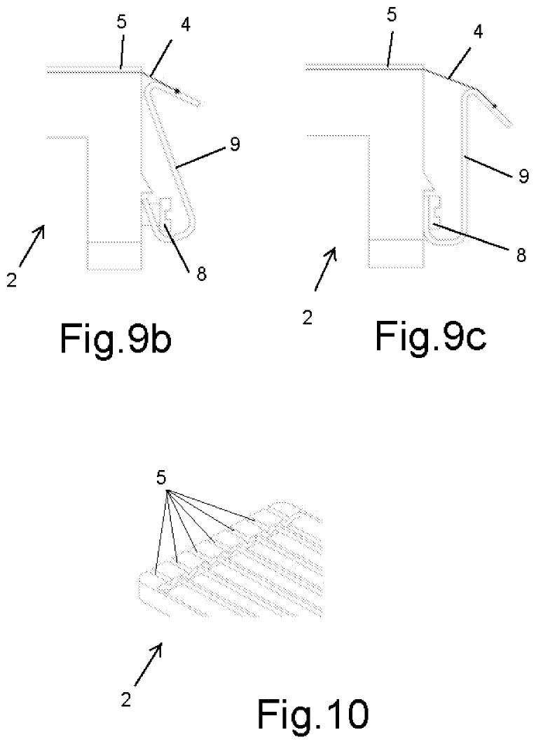

There is also a possibility of hybrid anchoring by means of plates (9) and screws (8) of the emitter wire or electrode (4) to its support (5). FIG. 9a, FIG. 9b and FIG. 9c show an example of this hybrid anchoring of the emitter electrodes (4) to their supports (5). The emitter wire or electrode (4) is welded to the plate (9). The plate is attached to the structure of the second body (2) by means of one or more screws (8). This system makes it possible to adjust the tension of the emitter wire or electrode (4) and to withstand vibrations and shocks. When the screws are not fully tightened or threaded (see FIG. 9b), the plate (9) can be placed in a position in which the emitter wire or electrode (4) is not tight. When tightening or screwing the screw (see FIG. 9c), the plate (9) moves, tightening the wire or emitter electrode (4).

Preferably, the emitter wire or electrode (4) is located at a distance (G) from each collector electrode (3) of between 1 mm and 4 mm. When the supply voltage of the emitter electrode (4) is low, the smaller the distance (G), the greater the power density per length of wire or emitter electrode (4).

For its part, as can be seen in FIG. 3, the separation (D) between collector electrodes (3) is between 1.5 and 2.5 times the distance (G) from the emitter electrode (4) to each collector electrode (3).

The separation between collector electrodes (3) (and/or between the two cylinders and divergent planes of the channel walls (6)) can be between 2.5 and 3.5 mm, according to a possible embodiment of the electrohydrodynamic ventilation device.

FIG. 4 schematically shows the electrical power supply of the electrohydrodynamic ventilation device. It is observed that each emitter electrode (4) is connected to a power supply source (10) and each collector electrode is connected to ground. The electric field lines (dashed lines) as well as the flow lines of the generated ionic wind (continuous lines following the walls of the channels (6), i.e., the lateral profile of the collector electrodes (3)) are also observed. Preferably, the voltage value of the power supply (10) is between 3000 V and 7000 V, with positive polarity. Thus, a specific power density between 0.5 W/cm and 2 W/cm in length of the emitter electrode (4) is generated. In this way, a sufficient electrical supply is achieved to guarantee the ionisation of the fluid (e.g., air) and that, in turn, no electric arcs are produced.

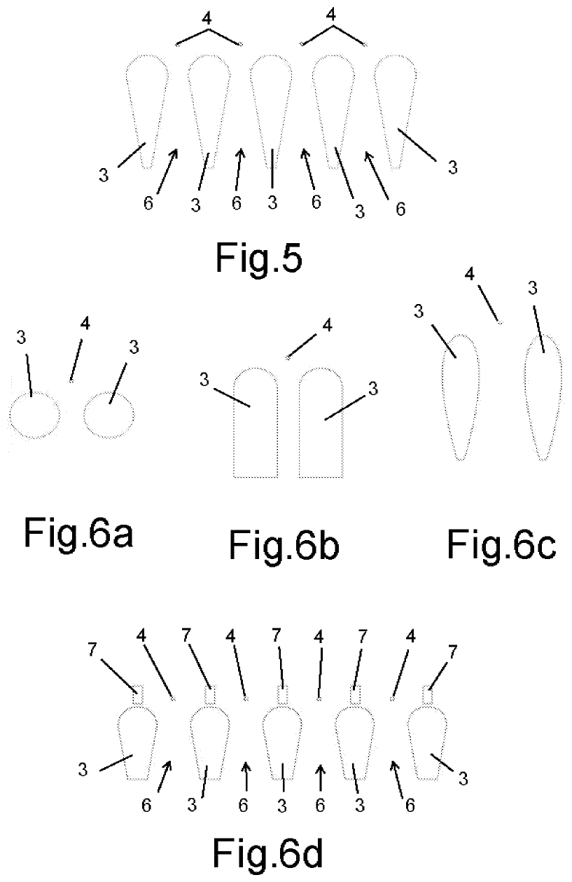

FIG. 5 shows an arrangement of collector electrodes (3) disposed in parallel, creating a channel (6) between each two collector electrodes (3) for the passage of the ionic wind flow. On each channel (6) there is an emitter electrode (4).

The collector electrodes (3) can have different geometries, according to various embodiments of the electrohydrodynamic ventilation device. Depending on the geometry of the collector electrodes (3), the channels (6) between each two collector electrodes (3) also adopt different geometries.

The channels (6) have two areas: an inlet area where the corona discharge occurs and an acceleration area where the ionic wind accelerates and adapts to its discharge to the environment.

The collector electrodes (3) can have a cylindrical geometry, as shown in FIG. 6a.

As shown in FIG. 6b, the collector electrodes (3) can have a partly cylindrical and partly prismatic geometry. In this case, the channel (6) created between each two collector electrodes (3) has a cylindrical inlet to continue with parallel walls, until the end of the two collector electrodes (3) defining the channel (6).

In both cases, both in the case of cylindrical collector electrodes (3) (FIG. 6a) and in the case of collector electrodes (3) with a partially cylindrical and partially prismatic geometry that generates parallel channel (6) walls, the output of the ionic wind flow from each channel (6) from the acceleration area towards the environment is abrupt, tending to generate a certain amount of turbulence at the outlet of the electrohydrodynamic ventilation device.

In order to achieve a smoother output of the ionic wind flow from each of the channels (6) (from the acceleration area of each channel (6) towards the environment), the collector electrodes (3) can have a geometry in the shape of an aerodynamic profile, for example, drop- or NACA-shaped (see FIG. 6c). This geometry of the collector electrodes (3) is the one that achieves the best ionic wind flow feature throughout the length of the channel (6), having a more laminar profile and a less abrupt outlet from the channel (6). Said symmetrical NACA profile (NACA duct) is thus generated in the channel (6).

The collector electrodes (3) can also have a partially cylindrical and partially trapezoidal geometry (see FIG. 6d), generating a channel (6) with divergent walls between each two collector electrodes (3). This geometry of the channel (6) also produces relatively smoother expansions than in the channels (6) shown in FIG. 6a and FIG. 6b.

The emitter electrodes (4) are preferably made of tungsten (or a tungsten alloy with a tungsten content of more than 95%), which gives them high mechanical resistance and good behaviour against degradation. The diameter of the emitter wire or electrode (4) is preferably between 5 microns and 100 microns.

For their part, according to a possible embodiment of the electrohydrodynamic ventilation device, the collector electrodes (3) are made of a conductive material, in order to provide the collector electrodes (39) with good behaviour against degradation.

Alternatively, as shown in FIG. 12a and FIG. 12b, the collector electrodes (3) may comprise a core (3.2) made of insulating material and a coating (3.1) made of conductive material (e.g., metal). As can be seen in these figures, in one embodiment the collector electrodes (3) have the shape of an aerodynamic profile, said coating (3.1) of conductive material being disposed on the leading edge of the profile.

The coating (3.1) made of conductive material interacts with the emitter electrode (4) to generate the ionic wind due to the corona effect, while the core (3.2) made of insulating material performs the functions of supporting the coating and isolating same from the first body (1) of the device.

The different shapes of the core (3.2) made of insulating material affect the shape of the channel (6) as can be seen in FIGS. 6a, 6b, 6c and 6d. Additionally, it is envisaged that the core (3.2) made of insulating material is configured as a catalyst to neutralise chemical compounds that could be produced in the corona effect.

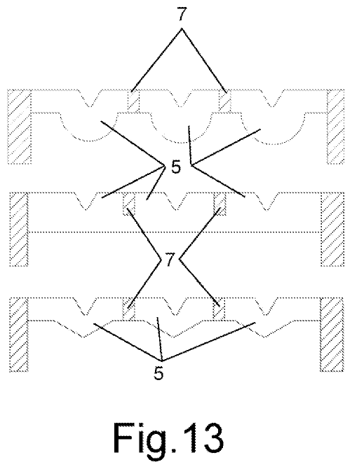

Alternatively, as shown in FIG. 13, by way of example, different possible geometries are designed for the supports (5) on the face facing the first body (1). These different geometries of the supports (5) make it possible to provide adequate insulation between the emitter electrode (4) and the collector electrode (3) in the area of the end of the first body (1).

1. An electrohydrodynamic ventilation device comprising at least one emitter electrode (4) and at least two collector electrodes (3) defining an acceleration channel (6) for a flow of ionic wind between the at least two collector electrodes (3), wherein the at least one emitter electrode (4) is disposed on the acceleration channel (6) throughout a length of said acceleration channel (6), wherein the at least one emitter electrode (4) is configured to be anchored to supports (5) made of insulating material, the supports comprising a projection section (5′) that is interposed between the at least one emitter electrode (4) and each end (3′) of the at least two collector electrodes (3).

2. The electrohydrodynamic ventilation device according to claim 1, further comprising a first body (1) and a second body (2), wherein the first body (1) comprises the at least two collector electrodes (3) and wherein the second body (2) comprises the support (5) for the at least one emitter electrode (4), wherein the second body (2) is configured to be mounted on the first body (1).

3. The electrohydrodynamic ventilation device according to claim 1, wherein the at least one emitter electrode (4) is configured to be anchored to the supports (5) by means of screws (8), so that by screwing or unscrewing the screws (8) a tightening or loosening of the at least one emitter electrode (4) is respectively allowed.

4. The electrohydrodynamic ventilation device according to claim 1, wherein the at least one emitter electrode (4) is configured to be anchored to the supports (5) by means of metallic plates (9) configured to act by way of springs, allowing vibrations or shocks on the electrohydrodynamic ventilation device to be absorbed.

5. The electrohydrodynamic ventilation device according to claim 1, wherein the at least one emitter electrode (4) is configured to be anchored to the supports (5) by means of a combination of plates (9) and screws (8).

6. The electrohydrodynamic ventilation device according to claim 1, further comprising a plurality of emitter electrodes (4) and a spacer (7) made of insulating material on each collector electrode (3), wherein said spacer (7) is configured to insulate the emitter electrodes (4) from one another, minimizing the interference of the electric field of one emitter electrode (4) with the electric field of another emitter electrode (4).

7. The electrohydrodynamic ventilation device according to claim 1, wherein each emitter electrode (4) is located at a distance (G) from each collector electrode (3) of between 1 mm and 4 mm.

8. The electrohydrodynamic ventilation device according to claim 7, wherein the collector electrodes (3) have between them a separation (D) of between 1.5 and 2.5 times the distance (G) from the emitter electrode (4) to each collector electrode (3).

9. The electrohydrodynamic ventilation device according to claim 8, wherein the separation (D) between collector electrodes (3) is approximately twice the distance (G) from the emitter electrode (4) to each collector electrode (3).

10. The electrohydrodynamic ventilation device according to claim 1, wherein the supports (5) comprise V-shaped channels configured to help position the emitter electrodes (4) correctly and parallelly.

11. The electrohydrodynamic ventilation device according to claim 1, wherein the collector electrodes (3) comprise a drop-shaped geometry generating a channel (6) with divergent walls between each two collector electrodes (3).

12. The electrohydrodynamic ventilation device according to claim 1, wherein the collector electrodes (3) comprise a partially cylindrical and partially trapezoidal geometry, generating a channel (6) with divergent walls between each two collector electrodes (3).

13. The electrohydrodynamic ventilation device according to claim 1, characterised in that wherein the collector electrodes (3) are made with a core (3.2) made of insulating material and a coating (3.1) of conductive material.
